(19) United States
(12) Patent Application Publication
(10) Pub. No.: US 2007/0082101 A1
(43) Pub. Date: Apr. 12, 2007

(54) Method for stably flavoring drinks

(76) Inventor: Johann Wiesmuller, Garching (DE)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/567,190

(22) PCT Filed: Aug. 5, 2004
(86) PCT No.: PCT/EP04/08789

§ 371 Date: Aug. 23, 2006

(30) Foreign Application Priority Data
Aug. 7, 2003 (DE) 10336146.4

(51) Int. Cl. A23L 1/22

(52) U.S. Cl. 426/534

(57) ABSTRACT

The invention concerns a method for stably flavouring drinks by means of solid, solvent-inert, particulate carrier materials loaded with flavouring agents having a large specific surface in which inorganic silicon, aluminium and/or carbon-containing compounds from the group comprising silicates, aluminium oxides and activated carbons, which optionally contain portions of water, are used as carrier materials. Silica gels, kieselguhr, activated and/or calcined clays, γ-Al₂O₃ and alumina oxide xerogels are particularly suitable as carrier materials which should have a specific surface between 0.1 and 1000 m²/g and a particle size of ≧10 μm. Suitable pore sizes of the carrier materials are those between 0.3 and 5000 nm. Suitable flavouring agents are essential oils, citrus oils, fruit essences and flavour extracts, for the loading of which the carrier materials are introduced into liquids containing flavouring agents or are sprayed with these. The method can in particular be used to stably flavour hot drinks for long periods.

The present invention concerns a method for stably flavouring drinks by means of solid, solvent-inert particulate carrier materials that are loaded with flavouring agents and have a large specific surface.

The use of carrier materials having a large specific surface to flavour foods has been known for a long time.

Flavouring agents generally have a complex structure and consist of numerous organoleptically active compounds which only form their characteristic aroma note as result of the specific combination of these compounds. However, flavouring agents are typically unstable in the undiluted state and thus it has been attempted to stabilize them with the aid of carrier materials and thus to make them easier to handle. For this purpose the carrier materials must be inert or at least be reaction neutral and above all they should not interact with the flavouring agents or adulterate the typical aroma note.

Water-soluble solids or liquids are used as carrier materials especially in the food sector where in the case of liquids they are usually encapsulated in a solid water-soluble matrix. If flavouring agents bound to carrier materials are added to liquids, the carrier materials that are used should be readily miscible with the liquids which is why ethanol, propylene glycol, glycerol, vegetable oils, benzyl alcohol etc. have traditionally become accepted as suitable carrier materials.

According to WO 02/49450 a particulate aroma composition which consists of a solid water-soluble matrix in which the flavouring agents are physically entrapped is used to aromatize food preparations. The flavouring agents are readily volatile aromas which, however, are different from natural essential oils. An organic compound which is also readily volatile is selected as a carrier material which is stable in a liquid state under atmospheric pressure and at 25° C. and has a vapour pressure of at least 0.01 mm/hg at 25° C. and a boiling point between 25 and 250° C. In addition the density must be <1.0 g/cc at 25° C. and the water-solubility may not be more than 10% at 25° C. For this purpose synthetic carrier materials from the group consisting of monoterpenes, hydrocarbons, esters and alkyl furans are preferred such as d-limonene, 2-ethylfuran, 2-methylfuran or ethyl acetate.

Encapsulated odiferous substances and/or aromas having special releasing characteristics are known from the International Application WO 00/16643. The encapsulated aromas are covered with modified cellulose where the cellulose is able to reversibly form a gel when the temperature is increased. These aroma or odour particles are preferably produced by fluidized-bed spray granulation of an aqueous emulsion consisting of aroma and hydrophilic carriers. These encapsulated aromas are used in the production of foods or consumables and in particular of teabags, instant sauce powders, but also to produce pasteurized drinks. This variant of flavouring drinks among others utilizes the so-called reversible thermal gelation of cellulose derivatives which are used as a protective matrix for temperature-sensitive substances. When producing flavoured water-containing solvents which have to be subjected to a heating process, this enables an effective control of the aroma release since the release rate in the cooling phase can be specifically controlled in a time-and temperature-dependent manner even to the extent of complete solubility in cold water. The particles used for this have a diameter between 10 and 5,000 μm.

A flavour carrying agent which essentially consists of β-dextrin of a defined degree of polymerization is described in the U.S. Pat. No. 5,482,560 where the dextrin was obtained from starch. The primary use of this flavour carrying agent is to aromatize drinks with not-completely water-soluble aroma oils from which emulsions can be produced with the aid of dextrins in order to encapsulate them in a dry product.

A food product is known from WO 90/08478 which contains porous polymer beads that are impregnated with flavouring components. The spherical carrier materials which are essentially loaded with readily volatile substances can be coated with a water-soluble coating which can additionally melt under the influence of elevated temperatures. Essential oils and synthetic flavouring agents such as citrus oils, peppermint oils and fruit essences are mentioned as suitable flavouring agents. The carrier materials can be added to finished drinks and also to concentrates that are conceived for liquid drinks where the aroma is released into the drink during the storage or transport period and the release can be delayed by selecting suitable water-soluble coatings. The porous polymer beads consist of copolymers of divinyl-benzene and styrene or other monomers suitable for foods such as estragole, limonene or eugenol.

The European Patent Application 230 504 describes instant drinks in a powder, granulate or paste form which, in addition to cacao powder, can also contain flavouring agents and/or aromas and a carrier which is a protein that is dispersible in liquid.

Thus only organic compounds are known from the prior art in connection with the aromatization of foods and in particular drinks some of which are not thermally stable or must have an elevated cold water solubility. Moreover, the carrier particles used for aromatization are coated over a long period with coating materials.

Hence the main disadvantage of these known carrier materials is their thermolability and their inadequate aroma release over a long period in a non-coated state during which the carrier materials dissolve to a certain extent in the surrounding liquid matrix.

Thus from these known disadvantages of the prior art the object to be solved by the present invention is to provide a method for stably flavouring drinks by means of solid, solvent-inert particulate carrier materials that are loaded with flavouring agents and have a large specific surface and are used to maintain the stability of the released aromas over a long period especially at elevated temperatures and are also used to homogeneously flavour hot drinks over long periods in a constant quality.

This object is achieved with an appropriate method in which inorganic silicon-, aluminium- and/or carbon-containing compounds from the group comprising silicates, aluminium oxides and activated carbons are used which optionally have portions of water.

Surprisingly this method not only enabled the desired stable flavouring over long periods e.g. ≧1 h and in particular ≧1 day, but it was also found that the flavouring agents bound to the carrier material evolve very pure and intensive aroma notes. Moreover, it was unexpected that the “oil eyes” which otherwise occur on the liquid surface when water-containing drinks are flavoured with essential oils can be completely avoided and even hot drinks can be stably flavoured in a simple manner with extremely volatile flavouring agents.

The following carrier materials have proven to be particularly suitable for the present method: silica gels, kieselguhr, activated and/or calcined clays, γ-Al₂O₃ and aluminium oxide xerogels.

Kieselguhr is a naturally occurring amorphous silicic acid of fossil origin which is also referred to as diatomaceous earth, bacillary earth or diatomite. Aluminium oxide which is also suitable as a carrier material is generally subdivided into three classes namely into the a modification, into the so-called γ forms and into special forms. γ Forms refer to all thermodynamically unstable Al₂O₃ forms which occur between 400 and 1000° C., which are also denoted non-stoichiometric aluminium hydroxides with reference to the OH⁻ groups present on the surface. Activated carbons are industrially manufactured carbon-containing products that are easy to handle and have a porous structure and a large inner surface. As a result they can adsorb a very wide spectrum of substances i.e. retain molecules on their inner surface. The pore volumes of activated carbons is generally larger than 0.2 mL/g and the inner surface is >400 m²/g. Their pore size ranges from 0.3 to a few 1000 nm.

In order to cover the widest possible spectrum of flavouring agents that are to be adsorbed, the invention envisages the use of carrier materials which have a specific surface between 0.1 and 1000 m²/g, where surfaces between 50 and 500 m²/g are preferred. The carrier materials preferably have a large specific surface and in particular a specific surface of at least 1, more preferably of at least 10 and even more preferably of at least 100 m²/g.

Carrier materials are also preferred which have a pore size between 0.3 and 5000 nm, preferably between 1 and 1000 nm and even more preferably between 10 and 100 nm.

With regard to particle size, carrier materials are particularly suitable within the scope of the method according to the invention whose particle sizes per single particle are ≧10 μm, in particular ≧20 μm and even more preferably ≧50 μm.

The present method makes no limitations on the water content of the carrier materials but the water content should preferably not exceed 25% by weight and in particular 10% by weight based on the carrier material.

As already indicated the present method has particular advantages with regard to stably flavouring drinks and especially hot drinks. In this connection the invention also envisages a process variant in which the carrier materials are loaded with readily volatile flavouring agents preferably of natural origin.

As a whole it is recommended to use essential oils, citrus oils, fruit essences and aroma extracts as flavouring agents for the claimed method which can of course also be applied to the carrier materials in any mixtures.

The advantages of the method according to the invention become particularly apparent when the carrier materials loaded with the flavouring agents are added to aqueous infusion or extraction drinks and preferably teas. The temperature of the drinks to be flavoured is generally unimportant but the flavouring succeeds in an impressively more stable and homogeneous manner especially in the case of hot drinks. Such hot drinks are usually present at a temperature of ≧4020 C., in particular ≧60° C. and even more preferably ≧80° C.

With regard to loading the carrier materials with the flavouring agents that are to be released into the drinks at a later time, the present invention envisages two process variants in which, on the one hand, the carrier materials have been introduced into liquids containing flavouring agents in order to load them with the flavouring agents which can also be combined with stirring processes or in which the carrier materials are sprayed with liquids containing flavouring agents.

Process water derived from the aroma industry and in this case preferably from aroma extraction, aroma preparation and/or aroma processing has proven to be particularly suitable as a representative of liquids containing flavouring agents for the two aforementioned process variants. Of course aroma concentrates are equally well suited as liquids containing flavouring agents.

Although the carrier materials claimed within the scope of the present method exhibit their outstanding properties of a constant and stable release of flavouring agents over long periods without any additional treatment, in the case of special applications it is also possible to coat these carrier materials after they have been loaded with the flavouring agents which is in particular possible together with functional materials. These finctional coating materials can for example contain foods, dyes or sweeteners and dissolve before the flavouring agents are released into the drink matrix.

There are basically no constraints on the use of the claimed method for stably flavouring drinks which is why the carrier materials loaded with the flavouring agents can be directly added to the drinks that are to be flavoured or can also be admixed with raw materials for drinks such as instant powders. The carrier materials can also be added to functional units within the scope of the method according to the invention such as for example teabags or effervescent powders or effervescent tablets. Overall the method according to the invention is a simple method for stably and homogeneously adding pure aroma notes to drinks in a uniform manner and over a long period.

The present invention concerns a method for stably flavouring drinks by means of solid, solvent-inert, particulate carrier materials that are loaded with flavouring agents and have a large specific surface wherein inorganic silicon, aluminium and/or carbon-containing compounds from the group comprising silicates, aluminium oxides and activated carbons which optionally contain portions of water are used as carrier materials. Especially suitable carrier materials are silica gels, kieselguhr, activated and/or calcined clay, γ-Al₂O₃ and alumina oxide xerogels which should have a specific surface between 0.1 and 1000 m²/g and a particle size of ≧10 μm. Suitable pore sizes of the carrier materials are between 0.3 and 5000 nm. Suitable flavouring agents are essential oils, citrus oils, fruit essences and aroma extracts which are loaded onto the carrier materials by introducing the carrier materials into appropriate liquids containing flavouring agents or spraying them with these agents. This method allows especially hot drinks to be stably flavoured over long periods.

The following examples illustrate the advantages ofthe claimed method.

### EXAMPLES

### Example 1 (Invention)

100 g orange oil (sweet) was intensively stirred for 90 minutes with 30 g commercial silica gel. After the silica gel had sedimented, the supernatant orange oil was decanted and the loaded silica gel was centrifuged until no more centrifugate appeared.

Afterwards 100 g black tea powder was mixed with 5 g of the loaded silica gel.

2 g of this mixture were scalded in a cup with 200 ml boiling water, briefly stirred and allowed to stand for 3 minutes. Afterwards the finished tea drink was decanted.

The black tea flavoured in this manner has a particularly intensive typical orange note, moreover, it has no oil eyes and its aroma note can also be sensorily detected for several hours.

### Example 2 (Invention)

1.5 ml of a natural apple aroma extract diluted 5-fold with ethanol was sprayed onto 5 g commercial silica gel. Subsequently 50 g black tea powder was mixed with the loaded silica gel. 200 ml boiling water was poured over 1.5 g of this mixture in a cup, it was briefly stirred and allowed to stand for 2 minutes. Afterwards the finished tea drink was decanted.

The apple black tea that was obtained contains all typical and intensive notes of an apple aroma which could also be sensorily detected during the cooling phase and even 3 hours afterwards.

### Example 3 (Comparison)

50 g black tea powder was sprayed with 1.5 ml of an ethanolic apple aroma extract diluted 5-fold with ethanol. 200 ml boiling water was poured over 1.5 g of this mixture in a cup, it was briefly stirred and allowed to stand for 2 minutes. Afterwards the finished tea drink was decanted.

The apple aroma note that was still detectable at the moment of brewing could no longer be sensorily detected in the final tea drink.

1.-11. (canceled)

12. Method for flavouring drinks by means of solid, solvent-inert, particulate carrier materials loading with flavouring agents, characterized in that inorganic silicon, aluminium and/or carbon-containing compounds from the group comprising silicates, aluminium oxides and activated carbons, which optionally contain portions of water, are used as carrier materials which have a specific surface between 0.1 and 1000 m²/g and preferably of 50 to 500 m²/g.

13. Method as claimed in claim 12, characterized in that silica gels, kieselguhr, activated and/or calcined clays, γ-Al₂O₃ or/and aluminium oxide xerogels are used as carrier materials.

14. Method as claimed in claim 12, characterized in that carrier materials having a pore size between 0.3 and 5000 nm are used.

15. Method as claimed in claim 12, characterized in that carrier materials having a particle size of ≧10 μm are used.

16. Method as claimed in claim 12, characterized in that carrier materials loaded with readily volatile flavouring agents preferably of natural origin are used.

17. Method as claimed in claim 16, characterized in that the flavouring agents are essential oils, citrus oils, fruit essences and flavour extracts.

18. Method as claimed in claim 12, characterized in that the loaded carrier materials are added to aqueous infusion or extraction drinks and preferably to teas.

19. Method as claimed in claim 12, characterized in that the carrier materials are loaded with the flavouring agents by introducing them into liquids containing flavouring agents.

20. Method as claimed in claim 12, characterized in that the carrier materials are loaded with the flavouring agents by spraying them with liquids containing flavouring agents.

21. Method as claimed in claim 19, characterized in that the liquids containing the flavouring agents are process water from the flavour industry and preferably from flavour extraction, flavour preparation and/or flavour processing or they are flavour concentrates.

22. Method as claimed in claim 20, characterized in that the liquids containing the flavouring agents are process water from the flavour industry and preferably from flavour extraction, flavour preparation and/or flavour processing or they are flavour concentrates.
